(19) United States
(12) Patent Application Publication
(10) Pub. No.: US 2005/0273195 A1
(43) Pub. Date: Dec. 8, 2005

(54) Controller for movable systems

(75) Inventor: Bruce A. Williams, Endwell, NY (US)

Correspondence Address: PERKINS, SMITH & COHEN LLP, ONE BEACON STREET, 30TH FLOOR, BOSTON, MA, 02108, US

(73) Assignee: Lockheed Martin Corporation, Bethesda, MD (US)

(21) Appl. No.: 10/863,851

(22) Filed: Jun. 8, 2004

(51) Int. Cl. G06F 7/00

(52) U.S. Cl. 700/230

(57) ABSTRACT

A controller for movable systems. The controller comprises one or more electromechanical switches having an electrical input port. Each electromechanical switch has two switch states, and two electrical terminals. Each electrical input port is connected to one of the two electrical terminals. Each electrical input port can receive an electrical signal having at least two electrical states. The electromechanical switch provide a short circuit across the two output terminals when the electrical signal is in one of the electrical states.

### BACKGROUND OF THE INVENTION

This invention relates generally to movable systems and, more particularly, to controllers for movable systems and systems utilizing the controller.

Movable systems abound in processing and manufacturing facilities. In a specific example, conveyor systems are used for the movement of large numbers of product units, such as a tray or pallet, around a manufacturing or processing facility. In many movable system (such as, conveyor) applications, it is desirable to have a “soft” start along with a “hard” stop. That is, the conveyor will start to move using a limited acceleration mode (a “soft” start), then build up to full speed. When it is desired to stop the conveyor's movement, a “hard” stop is desired. The controller systems which have been previously described utilize solid state components which have to be protected from damage and noise transients.

There is a need for a simple robust controller for movable systems.

There is also a need for a simple robust controller for movable systems that can provide a “soft” start along with a “hard” stop.

### SUMMARY OF THE INVENTION

Simple robust controllers for movable systems that can provide a “soft” start along with a “hard” stop are disclosed.

The controller of this invention comprises one or more electromechanical switches, one or more electrical input port. Each electromechanical switch has at least two switch states, and at least two electrical terminals. Each electrical input port is operably connected to one of the two electrical terminals. Each electrical input port is capable of receiving an electrical signal having at least two electrical states. Each electromechanical switch is in one of the at least two switch states (“state 1”) when the electrical signal received from the electrical input port is in one of the at least two electrical states (“electrical state 1”). The one or more electromechanical switches provide a voltage source across two output terminals when at least one electrical signal is in one of the electrical states (“electrical state 1”). Each electromechanical switch is in another one of the at least two switch states (“state 2”) when the electrical signal received from the electrical input port is in another one of the at least two electrical states (“electrical state 2”). The electromechanical switches provide a short circuit across the two output terminals when the electrical signal is in another one of the electrical states (“electrical state 2”).

The controller of this invention can also include at least one processor system operably connected to the at least one electrical input port. The processor system is capable of providing the electrical signal to the electrical input port.

A conveyor system of this invention includes a support frame, at least one conveyor zone, where the at least one conveyor zone has a conveyor mechanism mounted on the support frame, at least one controller of this invention, at least one processor sub-system, and at least one electrical motor. The electrical motor is electrically connected to the two output terminals of the controller. The electrical motor is also mechanically connected to the conveyor mechanism in the conveyor zone. Substantially maximum deceleration is obtained by dynamic braking produced by shorting the output terminals. When it is desired to stop the conveyor's movement, a “hard” stop would be enabled by the dynamic braking.

For a better understanding of the present invention, together with other and further objects thereof, reference is made to the accompanying drawings and detailed description and its scope will be pointed out in the appended claims.

### BRIEF DESCRIPTION OF THE DRAWINGS

FIG. 1 is a graphical schematic representation of one embodiment of the controller of this invention;

FIG. 2 is a graphical schematic representation of an embodiment of a three zone controller of this invention;

FIG. 3 is a pictorial representation of a conventional conveyor frame and mechanism;

FIG. 4 is a pictorial representation of a side rail of a conventional conveyor frame;

FIG. 5a is a pictorial representation of another embodiment of the controller of this invention; and,

FIG. 5b is another view of the embodiment shown in FIG. 5a.

### DETAILED DESCRIPTION OF THE PREFERRED EMBODIMENTS

Simple robust controllers for movable systems that can provide a “soft” start along with a “hard” stop and conveyor systems utilizing controller of this invention are disclosed.

An embodiment of the controller of this invention comprises one or more electromechanical switches, one or more electrical input port. Each electromechanical switch has at least two switch states, and at least two electrical terminals. Each electrical input port is operably connected to one of the two electrical terminals. Each electrical input port is capable of receiving an electrical signal having at least two electrical states. Each electromechanical switch is in one of the at least two switch states (“state 1”) when the electrical signal received from the electrical input port is in one of the at least two electrical states (“electrical state 1”). The one or more electromechanical switches provide a voltage source across two output terminals when at least one electrical signal is in one of the electrical states (“electrical state 1”). Each electromechanical switch is in another one of the at least two switch states (“state 2”) when the electrical signal received from the electrical input port is in another one of the at least two electrical states (“electrical state 2”). The electromechanical switches provide a short circuit across the two output terminals when the electrical signal is in another one of the electrical states (“electrical state 2”).

The controller of this invention can also include at least one processor system operably connected to the at least one electrical input port. The processor system is capable of providing the electrical signal to the electrical input port.

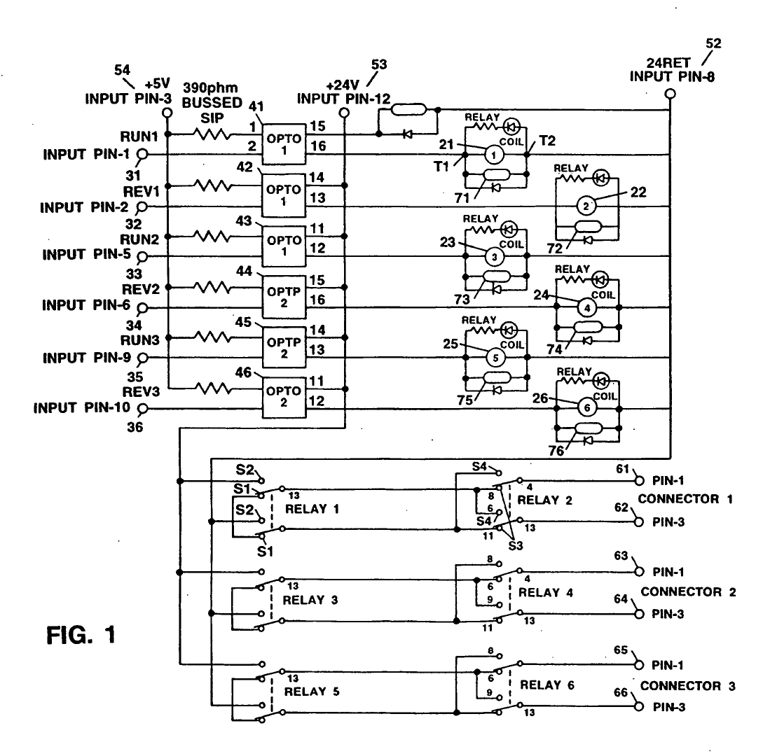

FIG. 1 is a graphical schematic representation of one embodiment of the controller of this invention. Referring to FIG. 1, the controller 10 independently controls three movable systems. The controller 10 of FIG. 1 includes electromechanical switches (relays, in this embodiment) 21, 22, 23, 24, 25, 26, and electrical inputs 31, 32, 33, 34, 35, 36. Each electromechanical switch (relay in this embodiment) 21, 22, 23, 24, 25, 26 has two switch states (S1 and S2 shown for electromechanical switch 21, S3 and S4 shown for electromechanical switch 22), and two electrical terminals (T1 and T2 shown for electromechanical switch 21). Each electrical input 31, 32, 33, 34, 35, 36 is electrically connected to one of the electrical terminals (T1 for electromechanical switch 21) of one of the electromechanical switches (relays, in this embodiment) 21, 22, 23, 24, 25, 26 through an isolating component, an opto-isolator in this embodiment, 41, 42, 43, 44, 45, 46. The opto-isolators 41, 42, 43, 44, 45, 46 protect the systems providing the electrical signals to electrical inputs 31, 32, 33, 34, 35, 36 from voltage surges. The electrical signals at electrical inputs 31, 32, 33, 34, 35, 36 electrically control the electromechanical switches (relays, in this embodiment) 21, 22, 23, 24, 25, 26. In one embodiment the electrical signals at electrical inputs 31, 32, 33, 34, 35, 36 are TTL signals (the electrical signals have two states). When electromechanical switch 21 is in state S2 and electromechanical switch 22 is in state S3 or S4, a voltage source provided across terminals 52 and 53 will be placed across output terminals 61 and 62. (In the embodiment shown in FIG. 1, the voltage source is a 24 volt DC source.) When electromechanical switch 21 is in state Si and electromechanical switch 22 is in state S3 or S4, a short circuit will be placed across output terminals 61 and 62. Electromechanical switches 23 and 24 and corresponding electrical inputs 33 and 34 and output terminals 63 and 64, and electromechanical switches 25 and 26 and corresponding electrical inputs 35 and 36 and output terminals 65 and 66 are each substantially identical in operation to electromechanical switches 21 and 22 and corresponding electrical inputs 31 and 32 and output terminals 61 and 62. A surge protection devices 71, 72, 73, 75 or 76 (a metal oxide varistor, MOV, in the embodiment shown in FIG. 1) is placed across each one of the electromechanical switches 21, 22, 23, 24, 25, 26.

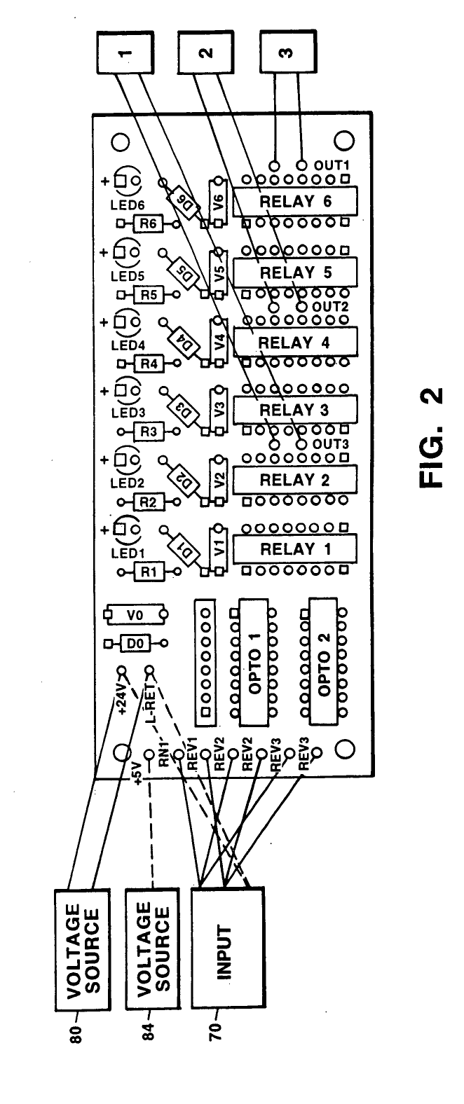

FIG. 2 is a graphical schematic representation of a board layout of the embodiment of a three zone controller of FIG. 1. Referring to FIG. 2, one or more processor systems 70 provide the electrical signals to electrical inputs 31, 32, 33, 34, 35, 36 (see also FIG. 1). A voltage source 80 is connected to terminals 52 and 53 (see also FIG. 1). Another voltage source 84 is connected to terminal 54. One motor 91 is connected across output terminals 61 and 62, corresponding to electromechanical switch (relay) 22. Another motor 92 is connected across output terminals 63 and 64, corresponding to electromechanical switch (relay) 24. A third motor 93 is connected across output terminals 65 and 66, corresponding to electromechanical switch (relay) 26. Electrical signals provided to electrical inputs 31 and 32 affect the state of electromechanical switches (relays) 21 and 22. Electrical signals provided to electrical inputs 33 and 34 affect the state of electromechanical switches (relays) 23 and 24. Electrical signals provided to electrical inputs 35 and 36 affect the state of electromechanical switches (relays) 25 and 26. In the embodiment shown in FIGS. 1 and 2, the motors 91, 92 and 93 are DC motors, the voltage sources 80 and 84 are DC voltage sources and the electrical signals provided to electrical inputs 31, 32, 33, 34, 35, 36 are two state (two level—TTL—high, low) signals.

During operation of the embodiment shown in FIGS. 1 and 2, when the electrical signal provided to electrical input 31 is placed in the “low state”, the controller 10 causes the voltage source 80 across terminals 52 and 53 to be placed across output terminals 61 and 62 in a manner as to cause the motor 91 to induce motion in a given direction (“forward”). When the electrical signals provided to electrical inputs 31 and 32 are both placed in the “low state”, the controller 10 causes the voltage source 80 placed across output terminals 61 and 62 to reverse polarity and to cause the motor 91 to induce motion in an opposite direction (“reverse”). When the electrical signal provided to electrical input 31 is removed, the controller 10 causes a short circuit to be placed across output terminals 61 and 62. The short circuit across output terminals 61 and 62 also short circuits the motor 91. Short circuiting the motor 91 causes the motor to operate in the dynamic braking mode, providing maximum deceleration of the movable system driven by the motor 91 and quickly bringing to rest the movable system driven by motor 91. The embodiment shown in FIGS. 1 and 2 comprises three channels that have completely independent inputs and outputs, each channel being capable of controlling one zone or segment of the movable system. The control of motor 92 by means of electrical signals provided to electrical inputs 33 and 34 and the state of electromechanical switches (relays) 23 and 24 and the control of motor 93 by means of electrical signals provided to electrical inputs 35 and 36 and the state of electromechanical switches (relays) 25 and 26 occur in a manner substantially similar to that described above.

The one or more processor systems 70 provide the electrical signals to electrical inputs 31, 32, 33, 34, 35, 36 and may be, but are not limited to, standard PCs, single board PCs or single board processor systems, or programmable logic controllers (PLC).

An embodiment of the controller of this invention can be utilized to control a conveyor mechanism, resulting in a conveyor system of this invention. A conveyor system of this invention includes a support frame, at least one conveyor zone, where the at least one conveyor zone has a conveyor mechanism mounted on the support frame, at least one controller of this invention, at least one processor sub-system, and at least one electrical motor. The electrical motor is electrically connected to the two output terminals of the controller. The electrical motor is also mechanically connected to the conveyor mechanism in the conveyor zone.

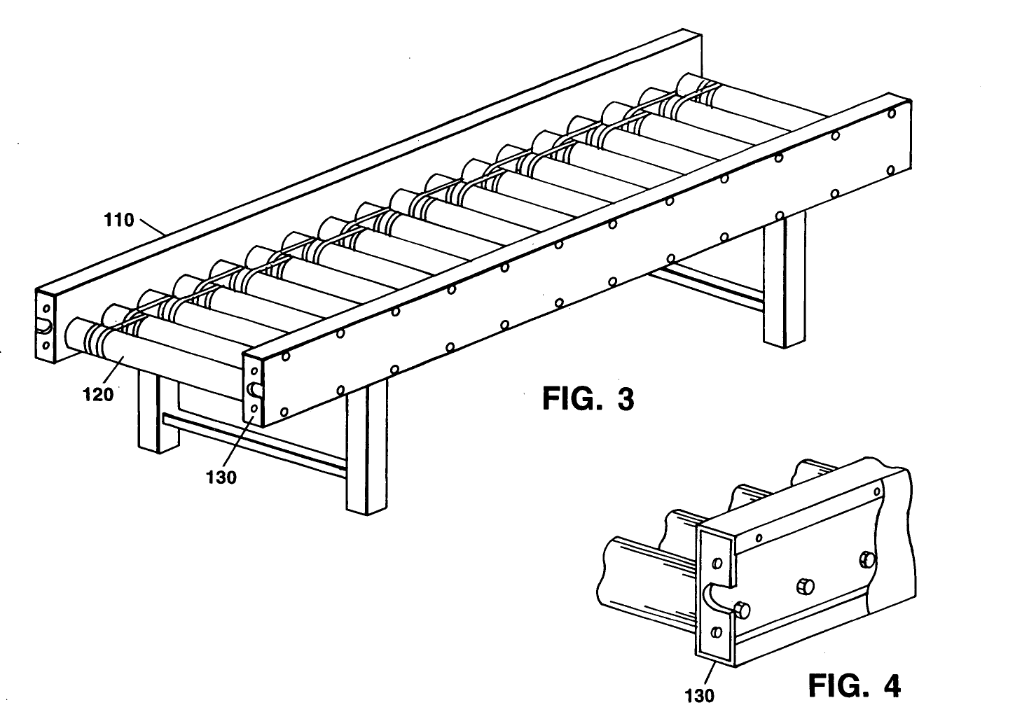

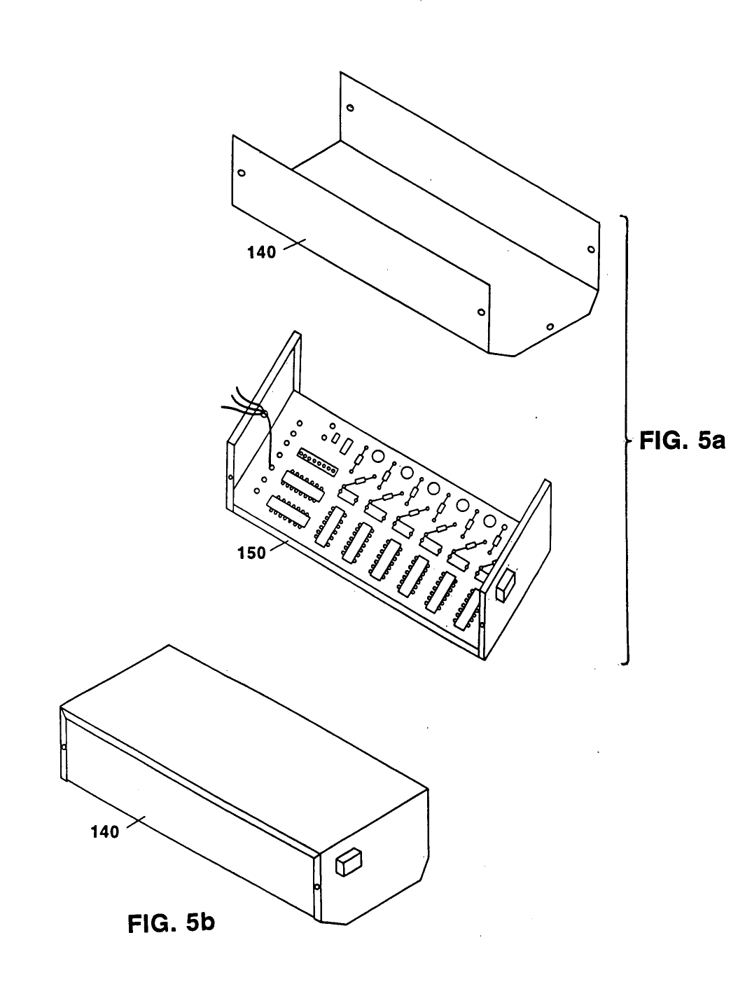

Shown in FIG. 3 is a pictorial representation of a conventional conveyor frame 110 and conveyor mechanism 120. FIG. 4 is a pictorial representation of a side rail 130 of a conventional conveyor frame 110. Shown in FIG. 5a (and also in FIG. 5b) is a pictorial representation of an embodiment of the controller of this invention in which the controller 150 is incorporated in a housing 140. The housing 140 having the controller 150 incorporated therewith can be mounted inside of the conveyor side rail 130. One or more electrical motors (not shown) are electrically connected to the output terminals (not shown) of the controller. The electrical motor is also mechanically connected to the conveyor mechanism 120 in the conveyor frame 110. The conveyor roller speed and acceleration are determined by the voltage and current supplied to the controller. Substantially maximum deceleration is obtained by the dynamic braking produced by shorting the output terminals. The speed and acceleration may be controlled by one or more processor systems. The one or more processor systems may perform other functions for the conveyor system or may be dedicated to provide controlling electrical signals to one or more controllers of this invention. The one or more processor systems may be, but are not limited to, standard PCs, single board PCs or single board processor systems, or programmable logic controllers (PLC).

Although the embodiment of the controller of this invention and the conveyor system of this invention have been described with respect to specific components, it should be noted that the controller of this invention is not limited to these components. For example, other surge protection devices, isolating components could be used.

Although the invention has been described with respect to various embodiments, it should be realized this invention is also capable of a wide variety of further and other embodiments within the spirit and scope of the appended claims.

1. A controller comprising:
at least one electromechanical switch having at least two switch states and at least two electrical terminals;
at least one electrical input port operably connected to one of said at least two electrical terminals;
said at least one electrical input port capable of receiving an electrical signal having at least two electrical states;
said at least one electromechanical switch being in one of said at least two switch states when the electrical signal is in one of said at least two electrical states;
said at least one electromechanical switch providing a voltage source across at least two output terminals when being in said one of said at least two switch states;
said at least one electromechanical switch being in another one of said at least two switch states when the electrical signal is in another one of said at least two electrical states; and,
said at least one electromechanical switch providing a short circuit across said at least two output terminals when being in said another one of said at least two switch states.

2. The controller of claim 1 further comprising:
at least one processor system operably connected to said at least one electrical input port;
said at least one processor system being capable of providing the electrical signal to said at least one electrical input port.

3. The controller of claim 1 further comprising:
at least one isolating component operably connecting said at least one electrical input port to said one of said at least two electrical terminals.

4. The controller of claim 1 further comprising:
at least one surge protection device operably connected across said at least two electrical terminals.

5. The controller of claim 1 wherein the voltage source is a DC voltage source.

6. A conveyor system comprising:
a support frame;
a conveyor mechanism mounted on said support frame;
at least one controller comprising:
at least one electromechanical switch having at least two switch states and at least two electrical terminals;
at least one electrical input port operably connected to one of said at least two electrical terminals; said
at least one electrical input port capable of receiving an electrical signal having at least two electrical states;
said at least one electromechanical switch being in one of said at least two switch states when said electrical signal is in one of said at least two electrical states; said at least one electromechanical switch providing a voltage source across said at least two output terminals when being in said one of said at least two switch states;
said at least one electromechanical switch being in another one of said at least two switch states when said electrical signal is in another one of said at least two electrical states; said at least one electromechanical switch providing a short circuit across said at least two output terminals when being in said another one of said at least two switch states;
at least one processor sub-system operably connected to said at least one electrical input port;
said at least one processor sub-system being capable of providing said electrical signal to said at least one electrical input port;
at least one electrical motor; said at least one electrical motor operably connected to said at least two output terminals; said at least one electrical motor being operably connected to said conveyor mechanism;
whereby substantially maximum deceleration of motion of the conveyor mechanism is obtained by dynamic braking when the short circuit is placed across the two output terminals to which the electrical motor is operably connected.

7. The conveyor system of claim 6 further comprising:
at least one housing;
said at least one housing having incorporated therewith said at least one controller.

8. The conveyor system of claim 7 wherein said at least one housing is disposed on said support frame.

9. The conveyor system of claim 7 wherein said at least one controller further comprises:
at least one isolating component operably connecting said at least one electrical input port to said one of said at least two electrical terminals.

10. The conveyor system of claim 7 wherein said at least one controller further comprises:
at least one surge protection device operably connected across said at least two electrical terminals.

11. The conveyor system of claim 7 wherein the voltage source is a DC voltage source.

12. A controller comprising:
a housing;
said housing having incorporated therewith:
at least one electromechanical switch having at least two switch states and at least two electrical terminals;
at least one electrical input port operably connected to one of said at least two electrical terminals; said
at least one electrical input port capable of receiving an electrical signal having at least two electrical states;
said at least one electromechanical switch being in one of said at least two switch states when the electrical signal is in one of said at least two electrical states; said at least one electromechanical switch providing a voltage source across at least two output terminals when being in said one of said at least two switch states;
said at least one electromechanical switch being in another one of said at least two switch states when the electrical signal is in another one of said at least two electrical states; said at least one electromechanical switch providing a short circuit across at least two output terminals when being in said another one of said at least two switch states.

13. The controller of claim 12 further comprising:
at least one processor system operably connected to said at least one electrical input port;
said at least one processor system being capable of providing said electrical signal to said at least one electrical input port.

14. The controller of claim 12 further comprising:
at least one isolating component operably connecting said at least one electrical input port to said one of said at least two electrical terminals.

15. The controller of claim 12 further comprising:
at least one surge protection device operably connected across said at least two electrical terminals.

16. The controller of claim 12 wherein the voltage source is a DC voltage source.

17. A controller comprising:
at least one electromechanical switch having at least two switch states and at least two electrical terminals;
at least one electrical input port;
at least one isolating component operably connecting said at least one electrical input port to one of said at least two electrical terminals;
said at least one electrical input port capable of receiving an electrical signal having at least two electrical states;
at least one surge protection device operably connected across said at least two electrical terminals;
said at least one electromechanical switch being in one of said at least two switch states when the electrical signal is in one of said at least two electrical states;
said at least one electromechanical switch providing a voltage source across at least two output terminals when being in said one of said at least two switch states;
said at least one electromechanical switch being in another one of said at least two switch states when the electrical signal is in another one of said at least two electrical states; and,
said at least one electromechanical switch providing a short circuit across said at least two output terminals when being in said another one of said at least two switch states.
